(19) United States
(12) Patent Application Publication
(10) Pub. No.: US 2025/0207858 A1
(43) Pub. Date: Jun. 26, 2025

(54) METHOD FOR OPERATING A BURNER OF A ROTARY KILN

(71) Applicants: thyssenkrupp Polysius GmbH, Beckum (DE); Vicat SA, L'Isle-d'Abeau (FR); Dyckerhoff GmbH, Wiesbaden (DE)

(72) Inventors: Karl LAMPE, Ennigerloh (DE); Eike WILLMS, Dortmund (DE); Ines VECKENSTEDT, Rietberg (DE); Jost LEMKE, Ennigerloh (DE); Thomas DECK, Ennigerloh (DE)

(73) Assignees: thyssenkrupp Polysius GmbH, Beckum (DE); Vicat SA, L'Isle-d'Abeau (FR); Dyckerhoff GmbH, Wiesbaden (DE)

(21) Appl. No.: 18/849,019

(22) PCT Filed: Mar. 17, 2023
(86) PCT No.: PCT/EP2023/056881

§ 371 Date: Sep. 20, 2024

(30) Foreign Application Priority Data
Mar. 21, 2022 (BE) BE 2022/5195
Mar. 21, 2022 (DE) 10 2022 202 711.6

(51) Int. Cl. F27B 7/34; F27B 7/42; F27D 19/00; F27D 99/00

(52) U.S. Cl. CPC F27B 7/34; F27B 7/42; F27D 19/00; F27D 99/0033; F27D 2019/0006

(57) ABSTRACT

A process includes operating a burner of a rotary kiln, wherein the gas streams supplied to the rotary kiln comprise in total more than 50% by volume of oxygen, wherein the burner has a burner orifice from which a fuel-gas mixture is discharged and wherein at least one state variable of the burner flame, in particular the ignition distance, the flame shape, the flame length and/or the flame width, is determined, wherein the flow velocity, the amount and/or the momentum of the fuel-gas mixture and/or the fuel properties is under open-loop/closed-loop control in accordance with the determined state variable. A rotary kiln for burning raw meal to cement clinker comprises a combustion zone designed within the rotary kiln, a burner having a burner orifice for discharging a fuel-gas mixture into the combustion zone, a measuring device that is designed and arranged such that it determines at least one state variable of the burner flame, in particular the ignition distance, the flame length and/or the flame width, wherein the rotary kiln has an open-loop/closed-loop control device designed such that it provides open-loop/closed-loop control of the flow velocity, the amount and/or the momentum of the fuel-gas mixture and/or the fuel properties in accordance with the determined state variable.

The invention relates to a process for operating a rotary kiln, in particular a burner within the rotary kiln, the rotary kiln being operated with an oxygen-rich gas.

Rotary kilns are commonly employed in the cement and mineral industry and are used for example to burn preheated cement raw meal to cement clinker.

The introduction of oxygen-containing gas for the combustion of carbon-containing fuels into the rotary kiln or the calciner of a cement production plant is known from the prior art. To reduce the amount of exhaust gas and in order to be able to dispense with laborious purification processes, it is known for example from DE 10 2018 206 673 A1 to use a combustion gas that is as rich as possible in oxygen, so that the CO₂ content in the exhaust gas is high and storage of the CO₂ or removal in the exhaust gas stream is facilitated. DE 10 2018 206 673 A1 discloses the introduction of an oxygen-rich gas into the cooler inlet region to preheat the gas and cool the clinker.

When using oxygen-enriched combustion gases having a high oxygen content of at least 30% to 100%, very high temperatures can arise in the kiln. If these high temperatures occur for a long period or continuously in the region of the kiln that is close to the wall, this can result in damage to the inner wall of the kiln. There is also the risk that very high temperatures will develop on the burner and in particular the burner mouth will be damaged.

Proceeding therefrom, it is an object of the present invention to provide a process for operating a rotary kiln, in particular a burner, where safe operation of the rotary kiln is ensured and at the same time an exhaust gas having a high CO₂ content is obtained.

This object is achieved according to the invention by a process having the features of independent process claim 1 and by a rotary kiln as claimed in independent claim 10. Advantageous developments will become apparent from the dependent claims.

In a process for operating a rotary kiln, in particular a burner of a rotary kiln, according to a first aspect the gas streams supplied to the rotary kiln consist in total of more than 50% by volume of oxygen, preferably giving rise to an oxygen-rich atmosphere within the rotary kiln having an oxygen content of more than 30% by volume, preferably more than 50% by volume, in particular more than 75% by volume. The oxygen-rich atmosphere is more particularly the averaged oxygen content within the rotary kiln as a whole, there being local regions in which an oxygen content of less than 50% by volume can occur. The burner has a burner orifice from which a fuel-gas mixture is discharged into the interior of the rotary kiln, in particular the combustion chamber, with at least one state variable of the burner flame, in particular the ignition distance, the flame shape, the flame length and/or the flame width, being determined. The flow velocity, the amount and/or the momentum of the fuel-gas mixture and/or the fuel properties is under open-loop/closed-loop control in accordance with, and preferably with influence on, the determined state variable.

The fuel properties are preferably the fuel moisture content, fuel composition, the calorific value and/or the particle size of the fuel.

The kiln is in particular a rotary kiln and preferably part of a cement production plant, the cement production plant comprising, for example:
a preheater for preheating raw meal,
a calciner for calcining the preheated raw meal,
a rotary kiln having a burner for burning the calcined hot meal into cement clinker, and
a cooler for cooling the cement clinker.

The rotary kiln comprises a burner, for example a burner lance and/or a single-channel or multi-channel burner for burning the calcined hot meal into cement clinker, the rotary kiln having a combustion gas inlet for admitting a combustion gas into the rotary kiln that has an oxygen content of 50% to 100% by volume, in particular at least 50% by volume, preferably at least 75% by volume. The combustion gas inlet is preferably installed in the kiln head, to which the cooler is connected. In particular, the combustion gas is formed at least in part from the exhaust air from the cooler. Optionally, the burner has a combustion gas inlet, in particular for open-loop and closed-loop control of the flame parameters, via which a combustion gas is introduced into the kiln. This combustion gas may differ in its composition from the combustion gas supplied via the cooler. In a specific embodiment, this combustion gas has an oxygen content of between 0 to 100%, in particular not more than 21%, preferably not more than 10%.

A preheater of the cement production plant preferably comprises a plurality of cyclone stages each having at least one cyclone for separating solids from the gas stream. In the preheater, the raw meal fed into the uppermost, first cyclone stage is preheated in countercurrent to the kiln exhaust gases and in the process passes through the cyclone stages one after the other.

The calciner is preferably arranged between the last and the penultimate cyclone stage and has a riser into which the raw meal is heated by means of a calciner firing system. In particular, the raw meal is deacidified and calcined in the calciner.

The raw meal preheated in the preheater and calcined in the calciner is then supplied to the rotary kiln. The rotary kiln has in particular a rotary tube that is rotatable about its longitudinal axis and is preferably slightly inclined in the direction of conveyance of the material to be burned, so that the material is moved in the direction of conveyance through the rotation of the rotary tube and through gravity. The kiln preferably has at one of its ends a material inlet for admitting preheated, calcined raw meal and at its end opposite the material inlet a material outlet for discharging the burned clinker into the cooler. A kiln head is preferably arranged at the material outlet-side end of the kiln and includes the burner for burning the material, in particular a fuel lance and/or a single-channel or multi-channel burner. The rotary kiln preferably has a sintering zone in which the material is at least partially melted and in particular has a temperature of 1500° C. to 1900° C., preferably 1450° C. to 1750° C. The sintering zone comprises for example the kiln head and in particular a sector of the rotary kiln at the rear end, preferably the rear third of the kiln in the direction of conveyance of the material.

The oxygen-containing combustion gas is for example introduced directly into the kiln head completely or in part, the kiln head having for example a combustion gas inlet. Preferably, the combustion gas is introduced completely or in part therein via the material outlet of the kiln. The combustion gas supplied to the kiln has for example an oxygen content of more than 30% by volume to 75% by volume, in particular more than 50% by volume, preferably more than 95% by volume. The combustion gas consists for example entirely of pure oxygen, in which case the oxygen content of the combustion gas is 100%. The burner may be for example a burner lance and/or a single-channel or multi-channel burner. A cooler for cooling the cement clinker is preferably connected to the material outlet of the kiln.

The cooler preferably has a conveying device for conveying the bulk material in the direction of conveyance through the cooling gas chamber. The cooling gas chamber is preferably arranged in the flow direction of the bulk material to be cooled, directly downstream of the cooler inlet, in particular the material outlet of the kiln, such that the clinker from the rotary kiln drops into the cooling gas chamber and in particular the heated cooling gas flow from the cooler enters the rotary kiln and forms the combustion gas at least in part.

The burner of the rotary kiln is preferably an in particular single burner lance and/or a single-channel or multi-channel burner having a plurality of pipes or channels arranged coaxially to one another. Preferably, the burner is mounted on the wall, in particular the inner wall, of the kiln head, in particular in a static region of the rotary kiln, and extends in particular in the axial direction, preferably in the center line of the rotary tube of the rotary kiln.

The burner comprises for example a plurality of pipes, in particular four pipes, that are arranged coaxially to one another and have differing diameters. A central pipe is arranged in the center line and forms a central channel. The central pipe with the smallest diameter serves for the transport of in particular lump fuel, such as substitute fuels from waste or production residues, for example used tires. Together with the fuel, a carrier gas serving for the pneumatic transport of the fuel is passed through the central pipe. The carrier gas is in particular an oxygen-poor gas having an oxygen concentration of 0% to 30% by volume, in particular 2% to 20% by volume, preferably 10% to 15% by volume, most preferably less than 10% by volume. Preferably, the transport gas has a CO2 concentration of 70% to 95% by volume, in particular 80% to 90% by volume, preferably more than 75% by volume. The remaining portion of the transport gas comprises preferably oxygen and/or water vapor and/or another inert gas component. The central pipe is preferably connected to a source of fuel, in particular lump substitute fuel, and a source of the transport gas.

Preferably, there is a swirl gas pipe arranged coaxially around the central pipe that forms a swirl gas channel. The swirl gas channel serves preferably for conducting a swirl gas having an oxygen content of 0% to 100% by volume, in particular 0% to 75% by volume, preferably less than 10% by volume. The swirl gas channel is preferably connected to a source for the swirl gas. The swirl gas pipe extends out over the central pipe, for example in an axial direction, in the direction of the burner orifice.

The fuel pipe is preferably arranged coaxially to the swirl gas pipe; this forms a fuel channel and is preferably designed for conducting a small-lump fuel, for example coal, and for conducting a carrier gas for the pneumatic transport of the fuel through the fuel channel. The carrier gas preferably has an oxygen content of 0% to 30% by volume, in particular 2% to 20% by volume, preferably less than 10% by volume. Preferably, the transport gas has a CO₂ concentration of 70% to 95% by volume, in particular 80% to 90% by volume, preferably more than 75% by volume. The remaining portion of the transport gas comprises preferably oxygen and/or water vapor. The fuel pipe extends out over the central pipe and the swirl gas pipe, preferably in an axial direction, in the direction of the burner orifice. The fuel channel is preferably connected to a source for the carrier gas and the in particular fine-grained fuel. Instead of the small-lump fuel, it is also possible to employ a liquid or gaseous fuel, which is introduced into the combustion chamber under pressure without a transport gas fraction.

The axial gas pipe is preferably arranged coaxially around the fuel pipe; this forms an axial gas channel and serves preferably for conducting an axial gas. The axial gas preferably has an oxygen content of 0% to 100% by volume, in particular 0% to 75% by volume, preferably less than 10% by volume, the axial gas channel preferably being connected to a source for the axial gas. The axial gas pipe extends out over the central pipe, the fuel pipe, and the swirl gas pipe, in particular in an axial direction, in the direction of the burner orifice.

The fuel-gas mixture comprises preferably the carrier gas, the axial gas and/or the swirl gas, and also a fine-grained fuel and/or a coarsely grained fuel, in particular a substitute fuel. The carrier gas, swirl gas and/or the axial gas comprise exhaust gas from the rotary kiln at least in part or completely discharged from the rotary kiln or exhaust gas from the cement production plant. The axial gas and the swirl gas preferably have a higher flow velocity relative to the carrier gas, so that the axial gas and the swirl gas preferably apply a swirl momentum to the mixture of fuel and carrier gas. In particular, the swirl gas pipe, in particular the burner orifice, is designed such that the swirl gas has an essentially tangential flow direction relative to the burner axis. Preferably, the axial gas pipe, in particular the burner orifice, is designed such that the axial gas has an essentially axial flow direction relative to the burner axis.

The terms open-loop control and closed-loop control are operations of automation technology. The term “closed-loop control” is understood as meaning an operation in which a variable, the control variable, is continuously recorded, compared with another variable, the reference variable, and influenced in the sense of an alignment with the reference variable. The term “open-loop control” is understood as meaning an operation in which at least one input variable influences other variables as output or control variables on the basis of the rules specific to the system. The term “adjustment” encompasses both open-loop and closed-loop control.

The ignition distance is the distance, preferably in the axial direction of the rotary kiln, between the burner orifice and the flame. In particular, the ignition distance is the smallest distance between the burner orifice and the burner flame. The flame length is preferably the extent of the burner flame in the axial direction of the rotary kiln, the flame width being the extent of the burner flame in the radial direction of the rotary kiln.

In a first embodiment, the state variable of the burner flame is compared with a limit value or limit range and, if the determined state variable deviates from the limit value or limit range, the flow velocity, the amount and/or the momentum of the fuel-gas mixture and/or the fuel properties adjusted. Preferably, each state variable of the burner flame has a respective limit value or a limit range. The limit range comprises preferably a maximum value and a minimum value, where undershooting the limit range comprises undershooting the minimum value and exceeding the limit value comprises exceeding the maximum value. Control of this kind makes it possible, through monitoring the state variables for the burner flame, to prevent damage to the burner.

In a further embodiment, the ignition distance is determined and compared with an ignition distance limit value or limit range, where, if the determined ignition distance deviates from the ignition distance limit value or limit range, the fuel moisture content, the particle size of the fuel, the CO2 content of the fuel-gas mixture and/or the oxygen content of the fuel-gas mixture is increased or decreased.

If the determined ignition distance undershoots the ignition distance limit value or limit range, it is preferable to increase the fuel moisture content and/or the particle size of the fuel. If the determined ignition distance exceeds the ignition distance limit value or limit range, it is preferable to decrease the fuel moisture content and/or the particle size of the fuel. In particular, if the ignition distance limit value or limit range is undershot, fine-grained material, such as lime powder or gypsum powder, is fed into the combustion zone of the rotary kiln through the burner, in particular through the fuel channel and/or the axial gas channel. This prevents ignition of the fuel close to the burner orifice. If the ignition distance limit value or limit range is undershot, it is also conceivable to increase the flow velocity of the carrier gas.

In a further embodiment, the burner has an axial gas channel through which an axial gas flows and exits the burner orifice in the essentially axial direction of the burner, and a swirl gas channel through which a swirl gas flows and exits the burner orifice in the essentially tangential direction of the burner. Preferably, the ignition distance is determined and compared with an ignition distance limit value or limit range, where, if the determined ignition distance deviates from the ignition distance limit value or limit range, the flow velocity, the oxygen content and/or the CO2 content of the axial gas and/or of the swirl gas is increased or decreased. Preferably, only axial gas flows through the axial gas channel and only swirl gas flows through the swirl gas channel, as per the description above. Adjusting the flow velocities of the axial gas and the swirl gas imparts a corresponding momentum to the mixture of fuel and carrier gas on exiting the burner orifice, with the result that the flame shape is accordingly adjustable.

In a further embodiment, the flame length is determined and compared with a flame length limit value or limit range, where, if the determined flame length deviates from the flame length limit value or limit range, the flow velocity and/or the momentum of the fuel-gas mixture is increased or decreased. The flow velocity of the fuel-gas mixture is adjusted preferably through adjustment of the flow velocities of the axial gas, swirl gas and/or carrier gas; such an adjustment preferably ensures optimal mixing between the fuel and the gases.

In a further embodiment, the flame length and/or the flame width is determined and compared with a flame length/flame width limit value or limit range, where, if the determined flame length or flame width deviates from the flame length/flame width limit value or limit range, water vapor, CO2 and/or solid particles are fed into the combustion zone. Preferably, the water vapor, the CO2 and/or the solid particles are fed into the rotary kiln, more particularly the combustion zone, via the burner and/or via a separate conduit. An input of water vapor, the CO2 and/or the solid particles cause, for example, a delay in the ignition and/or improved or decreased thermal expansion of the burner flame.

In a further embodiment, the burner has an axial gas channel through which an axial gas flows and exits the burner orifice in the essentially axial direction of the burner, and a swirl gas channel through which a swirl gas flows and exits the burner orifice in the essentially tangential direction of the burner. If the determined flame length deviates from the flame length limit value or limit range, the flow velocity of the axial gas in the axial gas channel and of the swirl gas in the swirl gas channel is increased or decreased.

If the determined flame length undershoots the flame length limit value or limit range, it is preferable to increase the flow velocity of the axial gas in the axial gas channel and/or to decrease the flow velocity of the swirl gas in the swirl gas channel. If the determined flame length exceeds the flame length limit value or limit range, preferably the flow velocity of the axial gas in the axial gas channel is decreased and/or the flow velocity of the swirl gas in the swirl gas channel is increased. The flow velocity of the carrier gas is preferably unchanged, depending on the determined flame length.

In a further embodiment, the exhaust gas from the rotary kiln is supplied at least in part to the burner. Preferably, the exhaust gas from the rotary kiln forms the carrier gas at least in part or completely. In particular, the exhaust gas from the rotary kiln is supplied thereto in part or completely via the burner or via a conduit arranged separately to the burner. The exhaust gas is for example at least in part exhaust gas from the cement production plant.

In a further embodiment, the state variable of the burner flame is determined using a camera, in particular an infrared camera.

The invention also encompasses a rotary kiln for burning raw meal to cement clinker having a combustion zone designed within the rotary kiln, a burner having a burner orifice for discharging a fuel-gas mixture into the combustion zone, a measuring device that is designed and arranged such that it determines at least one state variable of the burner flame, in particular the ignition distance, the flame length and/or the flame width. The rotary kiln has an open-loop/closed-loop control device designed such that it provides open-loop/closed-loop control of the flow velocity, the amount and/or the momentum of the fuel-gas mixture and/or the fuel properties in accordance with the determined state variable.

The embodiments and advantages described with reference to the process for operating a burner of a rotary kiln also apply in terms of apparatus to the rotary kiln for burning raw meal to cement clinker.

The measuring device is preferably designed such that it transmits the determined data, in particular the state variables for the burner flame, to the open-loop/closed-loop control device. The rotary kiln preferably has one or more gas inlets for admitting combustion gas, in particular oxygen. Preferably, the gas inlets of the rotary kiln are connected to at least one or more gas sources having a gas with an oxygen content of more than 50% by volume. Preferably, the open-loop/closed-loop control device is designed such that it establishes an oxygen content of more than 50% by volume, in particular more than 75% by volume, preferably more than 90% by volume, within the rotary kiln, more particularly the combustion zone. Preferably, the oxygen content within the kiln is overall greater than 50% by volume, there being local regions in which an oxygen content of less than 50% by volume can occur.

In one embodiment, the open-loop/closed-loop control device is designed such that it compares the state variable of the burner flame with a limit value or limit range and, if the determined state variable deviates from the limit value or limit range, it adjusts the flow velocity, the amount and/or the momentum of the fuel-gas mixture and/or the fuel properties.

In a further embodiment, the measuring device is designed such that it determines the ignition distance and the open-loop/closed-loop control device is designed such that it compares the determined ignition distance with an ignition distance limit value or limit range and, if the determined ignition distance deviates from the ignition distance limit value or limit range, it increases or decreases the fuel moisture content, the particle size of the fuel, the CO2 content of the fuel-gas mixture and/or the oxygen content of the fuel-gas mixture.

In a further embodiment, the burner has an axial gas channel that is designed such that an axial gas flows through it and exits the burner orifice in the essentially axial direction of the burner, and where the burner has a swirl gas channel that is designed such that a swirl gas flows through it and exits the burner orifice in the essentially tangential direction of the burner, and the measuring device is designed such that it determines the ignition distance. The open-loop/closed-loop control device is designed such that, if the determined ignition distance deviates from a predetermined ignition distance limit value or limit range, it increases or decreases the flow velocity, the oxygen content and/or the CO2 content of the axial gas and/or of the swirl gas.

In a further embodiment, the measuring device is designed such that it determines the flame length. The open-loop/closed-loop control device is preferably designed such that it compares the determined flame length with a flame length limit value or limit range and, if the determined flame length deviates from the flame length limit value or limit range, it increases or decreases the flow velocity and/or the momentum of the fuel-gas mixture.

In a further embodiment, the rotary kiln has a conduit for feeding water vapor, CO2 and/or solid particles into the combustion zone, wherein the measuring device is designed such that it determines the flame length and the open-loop/closed-loop control device is designed such that it compares the determined flame length with a flame length limit value or limit range and, if the determined flame length deviates from the flame length limit value or limit range, water vapor, CO2 and/or solid particles are fed into the combustion zone. Preferably, the rotary kiln has a conduit for feeding water vapor, CO2 and/or solid particles into the combustion zone that is separate to the burner. The conduit and/or the burner are preferably connected to a source of water vapor, CO2 and/or solid particles.

In a further embodiment, the burner has an axial gas channel that is designed such that an axial gas flows through it and exits the burner orifice in the essentially axial direction of the burner. The burner has a swirl gas channel that is designed such that a swirl gas flows through it and exits the burner orifice in the essentially tangential direction of the burner. The open-loop/closed-loop control device is preferably designed such that, if the determined flame length deviates from the flame length limit value or limit range, it increases or decreases the flow velocity of the axial gas in the axial gas channel and of the swirl gas in the swirl gas channel.

In a further embodiment, the rotary kiln has an exhaust gas outlet, the burner being connected to the exhaust gas outlet for conducting at least part of the exhaust gas into the burner.

In a further embodiment, the measuring device is a camera, in particular an infrared camera.

### DESCRIPTION OF THE DRAWINGS

The invention is explained in more detail below on the basis of multiple exemplary embodiments with reference to the appended figures.

FIG. 1 shows a schematic representation of a burner in a rotary kiln in a partial sectional view according to one exemplary embodiment.

FIG. 2 shows a schematic representation of a burner in a longitudinal sectional view according to one exemplary embodiment.

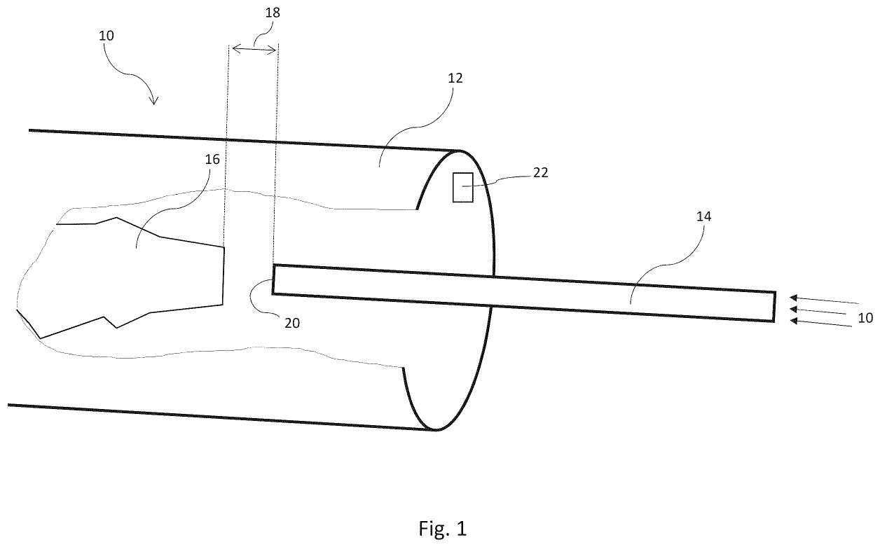

FIG. 1 shows a rotary kiln 10 having a rotary tube 12 and a burner 14 that is arranged within the rotary tube 12. The burner 14 is preferably attached to an inner wall of the rotary kiln 12 not shown in FIG. 1, the inner wall being a static inner wall that does not rotate with the rotary tube of the rotary kiln. For example, the burner 14 is mounted on the end wall arranged in the end region of the rotary tube or extends through it.

The rotary tube 12 is preferably arranged rotatably about its longitudinal axis and, in particular in the direction of the kiln head, in particular of the burner 14, has a downward alignment, so that the material to be burned is conveyed inside the rotary tube toward the burner 14 through gravity and through the rotation of the rotary tube 12.

FIG. 1 further shows a schematic representation of the flame 16 of the burner 14 and of the ignition distance 18. The ignition distance 18 is the distance, preferably in the axial direction of the rotary kiln 10, between the burner 14 and the flame 16. The burner 14 has a burner orifice 20 that forms the axial end of the burner 14 and from which the fuel from the burner 14 exits. In particular, the ignition distance 18 is the smallest distance between the burner orifice 20 and the flame 16.

The rotary kiln 10 preferably has a measuring device, in particular a camera 22, preferably an infrared camera, that is designed and arranged for determining the ignition distance 18. Preferably, the camera 22 is mounted on the inner wall of the rotary kiln 10, for example on the rotary tube 12 or the kiln head. It is also conceivable that the camera 22 is mounted on a static inner wall of the kiln head or outside the rotary kiln 10. The measuring device is preferably designed for determining the flame shape, flame length and flame width. Preferably, the measuring device is designed such that it detects a flame when the temperature exceeds a value of 1600° C. and/or when combustion of the fuel takes place. The measuring device preferably includes a cooling device for cooling the measuring device.

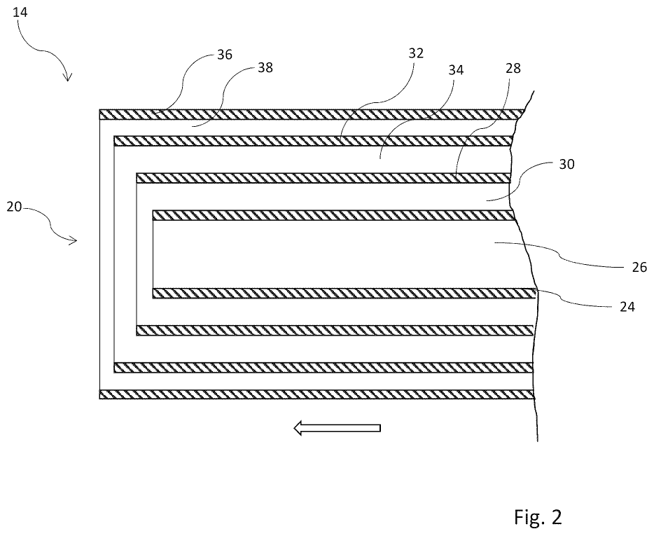

FIG. 2 showed the burner 14 in a sectional view, showing only the end region of the burner 14 extending into the rotary tube 12 with the burner orifice 20.

The burner 14 comprises by way of example four pipes that are arranged coaxially to one another and have differing diameters. The central pipe 24 having the smallest diameter serves for the transport of in particular lump fuel, such as substitute fuels from waste or used tires. The central pipe 24 forms a central channel 26. Together with the fuel, a carrier gas serving for the pneumatic transport of the fuel is passed through the central pipe 24. The carrier gas is in particular an oxygen-poor gas having an oxygen concentration of 0% to 35% by volume, in particular 2% to 20% by volume, preferably 10% to 15% by volume, most preferably less than 10% by volume. Preferably, the transport gas has a CO₂ concentration of 70% to 95% by volume, in particular 80% to 90% by volume, preferably more than 75% by volume. The remaining portion of the transport gas comprises preferably oxygen, nitrogen and/or water. The central pipe 24 is preferably connected to a source of fuel, in particular lump substitute fuel, and a source of the transport gas.

The swirl gas pipe 28, for example, is arranged coaxially to the central pipe 24, forming a swirl gas channel 30. The swirl gas channel 30 is preferably formed between the inner wall of the swirl gas pipe 28 and the outer wall of the central pipe 24 and serves preferably for conducting a swirl gas. The swirl gas pipe 28 extends out over the central pipe 24, for example in an axial direction, in the direction of the burner orifice 20. The swirl gas preferably has an oxygen content of 0% to 100% by volume, in particular 30% to 75% by volume, preferably more than 90% by volume. The swirl gas channel 30 is preferably connected to a source for the swirl gas.

The fuel pipe 32, for example, is arranged coaxially to the swirl gas pipe 28, forming a fuel channel 34. The fuel channel 34 is formed between the inner wall of the fuel pipe 32 and the outer wall of the swirl gas pipe 28 and serves preferably for conducting a small-lump fuel, for example coal, and also for conducting a carrier gas for the pneumatic transport of the fuel through the fuel channel 34. The fuel pipe 32 extends out over the central pipe 24 and the swirl gas pipe 28, for example in an axial direction, in the direction of the burner orifice 20. The carrier gas preferably has an oxygen content of 0% to 30% by volume, in particular 2% to 20% by volume, preferably 10% to 15% by volume, most preferably less than 10% by volume. Preferably, the transport gas has a CO₂ concentration of 70% to 95% by volume, in particular 80% to 90% by volume, preferably more than 75% by volume. The remaining portion of the transport gas comprises preferably oxygen, nitrogen and/or water. The fuel channel 34 is preferably connected to a source for the carrier gas and the in particular fine-grained fuel.

The axial gas pipe 36, for example, is arranged coaxially to the fuel pipe 32, forming an axial gas channel 38. The axial gas channel 38 is in particular formed between the inner wall of the axial gas pipe 36 and the outer wall of the fuel pipe 32 and serves preferably for conducting an axial gas. The axial gas pipe 36 extends out over the central pipe 24, the fuel pipe 32, and the swirl gas pipe 28, for example in an axial direction, in the direction of the burner orifice 20. The axial gas preferably has an oxygen content of 0% to 100% by volume, in particular 30% to 75% by volume, preferably more than 90% by volume. The axial gas channel 38 is preferably connected to a source for the axial gas.

The main flow direction of the gases is indicated by the arrow. The axial gas and the swirl gas preferably have a high flow velocity relative to the carrier gas. The flow direction of the axial gas is essentially in the axial direction of the burner, where the flow direction of the swirl gas is directed essentially in the tangential direction of the burner. The swirl gas and the axial gas serve preferably for applying an axial and swirl momentum to the fuel exiting from the burner orifice 20, in particular from the fuel channel 30 and the central channel 26.

The central channel 26, the swirl gas channel 30, the fuel channel 34, and the axial gas channel 38 are each connected to a device for adjusting the flow velocity and/or the amount of the respective gas, such as the carrier gas, axial gas or swirl gas. The device for adjusting the flow velocity and/or the gas amount is, for example, a valve, a fan, a nozzle and/or a diffuser.

The rotary kiln 10 has an open-loop/closed-loop control device connected to the camera 22 for transmitting the data determined by means of the camera 22, in particular the ignition distance, the flame length and/or the flame width. The open-loop/closed-loop control device is preferably connected to the device for adjusting the flow velocity and/or the gas amount and is designed for open-loop/closed-loop control of the flow velocity and/or the gas amount of the gases flowing respectively through the central channel 26, the swirl gas channel 30, the fuel channel 34 and the axial gas channel 38. Preferably, the open-loop/closed-loop control device is designed such that it adjusts, preferably increases, decreases or leaves unchanged, the flow velocity and/or the gas amount in accordance with the determined the ignition distance, the flame length and/or the flame width.

Preferably, the determined state variable of the burner flame is compared with a predetermined limit value or limit range and, if the determined state variable deviates from the limit value or limit range, the flow velocity, the amount and/or the momentum of the carrier gas and/or the fuel properties is adjusted. It is also conceivable that the flow velocity, the amount and/or the momentum of the carrier gas and/or the fuel properties are under open-loop control such that a respectively predetermined value for the flow velocity, amount and/or momentum of the carrier gas and/or for the fuel properties is assigned to the determined state variable, so that the flow velocity, the amount and/or the momentum of the carrier gas and/or the fuel properties are adjusted to the respective predetermined value in accordance with the determined state variable.

For example, the ignition distance is determined and compared with an ignition distance limit value or limit range. If the determined ignition distance undershoots the ignition distance limit value or limit range, the fuel moisture content and/or the particle size of the fuel, for example, is increased. If the determined ignition distance exceeds the ignition distance limit value or limit range, the fuel moisture content and/or the particle size of the fuel, for example, is decreased.

For example, if the ignition distance limit value or limit range is undershot, the CO₂ content in the carrier gas is increased and preferably the oxygen content of the carrier gas is decreased. If the determined ignition distance 18 exceeds the ignition distance limit value or limit range, the CO₂ content in the carrier gas, for example, is decreased and preferably the oxygen content of the carrier gas is increased. For example, if the determined ignition distance undershoots the ignition distance limit value or limit range, fine-grained material, such as lime powder or gypsum powder, is fed into the combustion zone of the rotary kiln 10 through the burner 14, in particular through the fuel channel 34 and/or the axial gas channel 38.

The burner 14 has a central channel 26 through which fuel flows together with a carrier gas. In addition, the burner 12 has a swirl gas channel 26 through which the swirl gas flows. The burner 12 also has an axial gas channel 38 through which the axial gas flows. In particular, the burner 12 has a fuel channel 34 through which fuel flows together with a carrier gas.

In particular, if the ignition distance limit value or limit range is undershot, the flow velocity and/or the amount of the carrier gas, in particular in the central channel 26 and/or the fuel channel 34, is increased. If the determined ignition distance 18 exceeds the ignition distance limit value or limit range, then for example the flow velocity and/or the amount of the carrier gas, in particular in the central channel 26 and/or the fuel channel 34, is decreased. Preferably, if the ignition distance limit value or limit range is undershot, the flow velocity of the axial gas in the axial gas channel 38 is increased, and if the ignition distance limit value or limit range is exceeded, it is decreased. Preferably, if the ignition distance limit value or limit range is undershot, the flow velocity of the swirl gas in the swirl gas channel 30 is increased, and if the ignition distance limit value or limit range is exceeded, it is decreased.

For example, the flame length is determined and compared with a flame length limit value or limit range. If the determined flame length undershoots the flame length limit value or limit range, then for example the flow velocity of the axial gas in the axial gas channel 38 and of the swirl gas in the swirl gas channel 30 is decreased and, if the limit value or limit range is exceeded, it is increased. The flow velocity of the carrier gas is, for example, not changed in accordance with the determined flame length. For example, if the flame length deviates from the flame length limit value or limit range, water vapor, CO₂ and/or solid particles will be fed into the combustion zone. These are fed in for example via the burner or via at least one additional conduit. The solid particles are fed in especially through the central channel or the fuel channel, wherein the water vapor and/or the CO₂ is preferably fed into the combustion zone through the axial gas channel 38 and/or the swirl gas channel 30. The solid particles are, for example, cement raw meal, limestone powder, calcined cement raw meal and/or fuel ash, which stimulate the heat radiation within the rotary kiln and thus influence the expansion of the burner flame.

If the determined flame length undershoots the flame length limit value or limit range, then for example the input of water vapor, CO₂ and/or the solid particles is increased, where, if the flame length limit value or limit range is undershot, the input is decreased.

For example, the flame shape is determined and compared with a multiplicity of predetermined flame shapes. Preferably, each flame shape is assigned a respectively predetermined value for the flow velocity, amount and/or momentum of the carrier gas and/or for the fuel properties, so that the flow velocity, the amount and/or the momentum of the carrier gas and/or the fuel properties are adjusted to the respective predetermined value in accordance with the determined flame shape. The flame shape is for example the two-dimensional or three-dimensional extent of the burner flame within the rotary kiln.

### LIST OF REFERENCE SIGNS

10 Rotary kiln
12 Rotary tube
14 Burner
16 Burner flame
18 Ignition distance
20 Burner orifice
22 Measuring device/camera
24 Central pipe
26 Central channel
28 Swirl gas pipe
30 Swirl gas channel
32 Fuel pipe
34 Fuel channel
36 Axial gas pipe
38 Axial gas channel

1-18. (canceled)

19. A process for operating a burner of a rotary kiln, comprising:
supplying gas streams to the rotary kiln, wherein the gas streams include in total more than 50% by volume of oxygen;
discharging a fuel-gas mixture from a burner orifice of the burner;
determining at least one state variable of a burner flame of the burner;
controlling a flow velocity, an amount and/or a momentum of the fuel-gas mixture and/or a fuel property in accordance with the determined state variable; and
supplying an exhaust gas from the rotary kiln at least in part to the burner.

20. The process as claimed in claim 19, wherein the state variable of the burner flame is compared with a limit value or limit range and, if the determined state variable deviates from the limit value or limit range, the flow velocity, the amount and/or the momentum of the fuel-gas mixture and/or the fuel property is adjusted.

21. The process as claimed in claim 19, wherein the state variable is an ignition distance and is determined and compared with an ignition distance limit value or limit range and wherein, if the determined ignition distance deviates from the ignition distance limit value or limit range, a fuel moisture content, a particle size of the fuel, a CO₂ content of the fuel-gas mixture and/or an oxygen content of the fuel-gas mixture is increased or decreased.

22. The process as claimed in claim 19, wherein:
the burner has an axial gas channel through which an axial gas flows and exits the burner orifice in an essentially axial direction of the burner and a swirl gas channel through which a swirl gas flows and exits the burner orifice in an essentially tangential direction of the burner;
the state variable is an ignition distance and is determined and compared with an ignition distance limit value or limit range; and
if the determined ignition distance deviates from the ignition distance limit value or limit range, then a flow velocity, an oxygen content, and/or a CO₂ content of the axial gas and/or the swirl gas is increased or decreased.

23. The process as claimed in claim 19, wherein the state variable is a flame length and is determined and compared with a flame length limit value or limit range and wherein, if the determined flame length deviates from the flame length limit value or limit range, then the flow velocity and/or the momentum of the fuel-gas mixture is increased or decreased.

24. The process as claimed in claim 19, wherein the state variable is a flame length and is determined and compared with a flame length limit value or limit range and wherein, if the determined flame length deviates from the flame length limit value or limit range, then water vapor, CO₂ and/or solid particles are fed into the combustion zone.

25. The process as claimed in claim 23, wherein:
the burner has an axial gas channel through which an axial gas flows and exits the burner orifice in an essentially axial direction of the burner and a swirl gas channel through which a swirl gas flows and exits the burner orifice in an essentially tangential direction of the burner; and
if the determined flame length deviates from the flame length limit value or limit range, then the flow velocity of the axial gas in the axial gas channel and of the swirl gas in the swirl gas channel is increased or decreased.

26. The process as claimed in claim 19, wherein:
the state variable includes an ignition distance, a flame shape, a flame length and/or a flame width; and
the controlling includes open-loop/closed-loop control.

27. The process as claimed in claim 19, wherein the state variable of the burner flame is determined using an infrared camera.

28. A rotary kiln for burning raw meal to cement clinker, comprising:
a combustion zone within the rotary kiln;
a burner having a burner orifice for discharging a fuel-gas mixture into the combustion zone; and
a measuring device that is designed and arranged to determine at least one state variable of the burner flame;
wherein the rotary kiln has an open-loop/closed-loop control device designed such that it provides open-loop/closed-loop control of a flow velocity, an amount and/or a momentum of the fuel-gas mixture and/or fuel properties in accordance with the determined state variable;
wherein the rotary kiln has an exhaust gas outlet and the burner is connected to the exhaust gas outlet for conducting exhaust gas into the burner.

29. The rotary kiln as claimed in claim 28, wherein the open-loop/closed-loop control device is designed such that it compares the state variable of the burner flame with a limit value or limit range and, if the determined state variable deviates from the limit value or limit range, it adjusts the flow velocity, the amount and/or the momentum of the fuel-gas mixture and/or the fuel properties.

30. The rotary kiln as claimed in claim 28, wherein the measuring device is designed such that it determines an ignition distance and the open-loop/closed-loop control device is designed such that it compares the determined ignition distance with an ignition distance limit value or limit range and wherein, if the determined ignition distance deviates from the ignition distance limit value or limit range, a fuel moisture content, a particle size of the fuel, a CO₂ content of the fuel-gas mixture and/or an oxygen content of the fuel-gas mixture is increased or decreased.

31. The rotary kiln as claimed in claim 28, wherein:
the burner has an axial gas channel designed such that an axial gas flows through it and exits the burner orifice in an essentially axial direction of the burner and the burner has a swirl gas channel that is designed such that a swirl gas flows through it and exits the burner orifice in an essentially tangential direction of the burner;
the state variable is an ignition distance and the measuring device is designed to determine the ignition distance; and
the open-loop/closed-loop control device is designed such that, if the determined ignition distance deviates from a predetermined ignition distance limit value or limit range, it increases or decreases the flow velocity, the oxygen content and/or the CO₂ content of the axial gas and/or of the swirl gas.

32. The rotary kiln as claimed in claim 28, wherein the state variable is a flame length and the measuring device is designed to determine the flame length and the open-loop/closed-loop control device is designed such that it compares the determined flame length with a flame length limit value or limit range and, if the determined flame length deviates from the flame length limit value or limit range, the flow velocity and/or the momentum of the fuel-gas mixture is increased or decreased.

33. The rotary kiln as claimed in claim 28, wherein the rotary kiln has a conduit for feeding water vapor, CO₂ and/or solid particles into the combustion zone and wherein the measuring device is designed to determine a flame length and the open-loop/closed-loop control device is designed to compare the determined flame length with a flame length limit value or limit range and, if the determined flame length deviates from the flame length limit value or limit range, water vapor, CO₂ and/or solid particles are fed into the combustion zone.

34. The rotary kiln as claimed in claim 32, wherein:
the burner has an axial gas channel designed such that an axial gas flows through it and exits the burner orifice in an essentially axial direction of the burner and the burner has a swirl gas channel that is designed such that a swirl gas flows through it and exits the burner orifice in an essentially tangential direction of the burner; and
the open-loop/closed-loop control device is designed such that, if the determined flame length deviates from the flame length limit value or limit range, it increases or decreases the flow velocity of the axial gas in the axial gas channel and of the swirl gas in the swirl gas channel.

35. The rotary kiln as claimed in claim 28, wherein the state variable includes an ignition distance, a flame length, and/or a flame width.

36. The rotary kiln as claimed in claim 28, wherein the measuring device is an infrared camera.
